(19) United States
(12) Patent Application Publication
(10) Pub. No.: US 2011/0304781 A1
(43) Pub. Date: Dec. 15, 2011

(54) VIDEO DISPLAY CONCEALMENT AND VIEWING APPARATUS

(76) Inventor: John R. Rowell, Kennesaw, GA (US)

(21) Appl. No.: 12/815,872

(22) Filed: Jun. 15, 2010

(51) Int. Cl. H04N 5/64

(52) U.S. Cl. 348/841; 348/E05.128

(57) ABSTRACT

A video display concealment and viewing apparatus is disclosed. The apparatus includes: a housing defined by a recessed area in a wall and a display opening in the recessed area; a video display cover operable between a revealed position in the opening and a concealed position to interchangeably rotate with a video display device, wherein one of the video display cover and the video display device is in the revealed position while the other is in the concealed position; a video display platform operable between an extended position and a retracted position and configured to hold the video display device flush with the wall in the extended position and hidden in the retracted position; a lift frame upon which the video display cover is conveyed between the revealed position and a concealed position; and a controller to control interchangeability between the video display cover and the video display device.

### FIELD OF THE INVENTION

The technology described herein relates generally to video displays and associated devices and methods by which to interchangeably conceal and reveal video displays. More specifically, this technology relates to a video display concealment and viewing apparatus, and associated methods, wherein the video display and an associated video display cover are interchangeably rotated to reveal the video display and to cover the video display as selected by an operator.

### BACKGROUND OF THE INVENTION

Televisions and video display devices are well known in the background art. In fact, both televisions and video display devices are ubiquitous, with many homes and offices, in fact, having multiple units. Over time televisions and video display devices have become increasingly large in size. Indeed, many contemporary large flat panel screen units consume several square feet of wall surface.

All the while television use has proliferated and the number and size of video display units have increased dramatically, persons have likewise increased their focus on home and office décor. Many have found that large video display screens are not adapted to match well with surrounding décor. In fact, particularly when a video display is not in use, it is desired to conceal the display in some manner to avoid an unappealing mismatch in décor.

Thus, there is a need in the art for a video display concealment and viewing apparatus and associated methods for providing a decorative covering for a video display that not only conceals and reveals the video display, but also selectively rotates interchangeably to reveal the video display and to cover the video display as selected by an operator.

Related utility patents known in the art include the following: U.S. Pat. No. 7,397,461 issued to Graham on Jul. 8, 2008, discloses a mirrored decorative video display concealment and cooling apparatus and method. U.S. Pat. No. 6,901,987 issued to Graham on Jun. 7, 2005, discloses a furled decorative covering apparatus and method. U.S. Pat. No. 7,337,024 issued to Graham on Feb. 26, 2008, discloses a flat panel and viewing apparatus and method. U.S. Pat. No. 7,316,379 issued to Graham on Jan. 8, 2008, discloses an adjustable mounting bracket for a flat panel display. U.S. Pat. No. 7,611,777 issued to Cheng on Nov. 3, 2008, discloses an ornamental structure for a thin type planar TV. U.S. Pat. No. 4,329,716 issued to Porco on May 11, 1982, discloses a combination television picture projection screen unit and ornamental cover unit thereof. U.S. Pat. No. 7,312,836 issued to Maxson on Dec. 25, 2007, discloses a television display cover. U.S. Pat. No. 5,264,765 issued to Pecorino et al. on Nov. 23, 1993, discloses a video display screen cover. U.S. Pat. No. 6,480,243 issued to Yamamoto on Nov. 12, 2002, discloses an installation structure for a panel display device. U.S. Pat. No. 7,287,737 issued to Rossi on Oct. 30, 2007, discloses a decorative cover frame assembly for selectively concealing a flat panel or high definition television display. U.S. Pat. No. 5,138,462 issued to Skovgard on Aug. 11, 1992, discloses a TV-set having a screen covering means. U.S. Pat. No. 6,846,083 issued to Mylar on Jan. 25, 2005, discloses a TV screen cover.

Related design patents known in the art include the following: U.S. Pat. No. D410,346 issued to Kerr on Jun. 1, 1999, discloses a combined television cabinet and artificial fireplace. U.S. Pat. No. D577,532 issued to Deeble on Sep. 30, 2008, discloses a flat panel TV cover.

The foregoing patent information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a device, system, and associated methods for a video display concealment and viewing apparatus.

In one exemplary embodiment, the technology described herein provides a video display concealment and viewing apparatus, for interchangeably concealing and viewing a video display device, as selected by an operator. The apparatus includes: a housing defined by a recessed area in a wall, or like structure, and a display opening in the recessed area; a video display cover operable between a revealed position in the display opening and a concealed position within the housing to selectively, interchangeably rotate with a video display device, wherein one of the video display cover and the video display device is in the revealed position in the display opening while the other is in the concealed position within the housing; a video display platform operable between an extended position and a retracted position and configured securely to hold the video display device flush with the wall in the extended position and hidden from view within the housing in the retracted position; a lift frame upon which the video display cover is mounted and conveyed between the revealed position in the display opening and a concealed position within the housing; and a controller to control operator selected interchangeability between the video display cover and the video display device.

The apparatus also can include: a horizontal conveyer assembly coupled to the video display platform and configured to convey the video display platform in a back-and-forth generally horizontal linear path in order to maintain the video display device between a first location in the display opening of the housing flush with the wall in the extended position and a second location hidden from view within the wall in the retracted position.

The apparatus further can include: a vertical conveyor assembly coupled to the lift frame and configured to convey the lift frame and the video display cover attached to the lift frame in a back-and-forth generally vertical linear path to maintain the video display cover in between a first location in the display opening of the housing flush with the wall in the revealed position and a second location in the concealed position within the housing and generally vertically above the display opening of the housing.

The apparatus also can include: a horizontal chain drive assembly disposed within the horizontal conveyer assembly and comprised of a chain drive motor and a chain apparatus that only bends about its link rollers in a single direction, the horizontal chain drive assembly configured to convey the video display platform in a back-and-forth generally horizontal linear path in order to maintain the video display device between the first location in the display opening of the housing flush with the wall in the extended position and the second location hidden from view within the wall in the retracted position.

The apparatus further can include: a vertical chain drive assembly disposed within the vertical conveyor assembly and comprised of a lift chain drive motor and a lift chain apparatus that only bends about its link rollers in a single direction, the vertical chain drive assembly configured to convey the lift frame and the video display cover attached to the lift frame in a back-and-forth generally vertical linear path to maintain the video display cover between the first location in the display opening of the housing flush with the wall in the revealed position and the second location in the concealed position within the housing and generally vertically above the display opening of the housing.

The apparatus also can include: a counterweight apparatus disposed within the housing and coupled to the vertical chain drive assembly to offset a weight of the lift frame and video display cover.

The apparatus further can include: a remote controller coupled in wireless communication to the controller to enable operation of the video display concealment and viewing apparatus remotely.

The apparatus also can include: a rack and pinion wheel assembly coupled to a display cover drive assembly, the rack and pinion wheel assembly disposed with the lift frame and configured selectively to push and pull the video display cover, once the video display cover is lowered from within the housing to immediately behind the display opening, between a first location directly adjacent to the lift frame and a second location within the display opening mounted flush with the wall. In this embodiment, the display cover drive assembly can include a spring steel member coupled to the video display cover at a first end and coupled to the rack and pinion wheel assembly at a second end, such that rotation of the pinion wheel against the rack moves the spring steel member and thus the video display cover.

The apparatus further can include: at least one proximity sensor configured to communicate to the controller that the video display cover is in a correct position at either of the revealed position in the display opening or the concealed position within the housing.

The apparatus also can include: at least one proximity sensor configured to communicate to the controller that the video display platform is in a correct position at either of the extended position flush with the wall or the retracted position hidden from view within the housing.

The apparatus further can include: at least one proximity sensor configured to communicate to the controller that the video display cover is in a correct position at either of the first location directly adjacent to the lift frame and the second location within the display opening mounted flush with the wall.

The apparatus also can include: a retractable access panel defined within the housing and configured to provide access to an internal housing area even while either the video display device or the video display cover is flush with the wall.

In another exemplary embodiment, the technology described herein provides an installation structure for a video display and an associated video display cover. The installation structure includes: a housing having an approximately rectangular recess or opening that is formed in a wall, cabinet, or the like, for accommodating a video display device; a video display cover operable between a revealed position in the opening and a concealed position within the housing to selectively, interchangeably rotate with the video display device, wherein one of the video display cover and the video display device is in the revealed position in the display opening while the other is in the concealed position within the housing; a video display platform operable between an extended position and a retracted position and configured securely to hold the video display device flush with the wall in the extended position and hidden from view within the housing in the retracted position; a lift frame upon which the video display cover is mounted and conveyed between the revealed position in the display opening and a concealed position within the housing; a controller to control operator selected interchangeability between the video display cover and the video display device; and a rack and pinion wheel assembly coupled to a drive assembly, the rack and pinion wheel assembly disposed with the lift frame and configured selectively to push and pull the video display cover, once the video display cover is lowered from within the housing to immediately behind the display opening, between a first location directly adjacent to the lift frame and a second location within the display opening mounted flush with the wall, wherein the drive assembly comprises a spring steel member coupled to the video display cover at a first end and coupled to the rack and pinion wheel assembly at a second end, such that rotation of the pinion wheel against the rack moves the spring steel member and thus the video display cover.

The installation structure also can include: a horizontal conveyer assembly coupled to the video display platform and configured to convey the video display platform in a back-and-forth generally horizontal linear path in order to maintain the video display device between a first location in the display opening of the housing flush with the wall in the extended position and a second location hidden from view within the wall in the retracted position; a horizontal chain drive assembly disposed within the horizontal conveyer assembly and comprised of a chain drive motor and a chain apparatus that only bends about its link rollers in a single direction, the horizontal chain drive assembly configured to convey the video display platform in a back-and-forth generally horizontal linear path in order to maintain the video display device between the first location in the display opening of the housing flush with the wall in the extended position and the second location hidden from view within the wall in the retracted position; a vertical conveyor assembly coupled to the lift frame and configured to convey the lift frame and the video display cover attached to the lift frame in a back-and-forth generally vertical linear path to maintain the video display cover in between a first location in the display opening of the housing flush with the wall in the revealed position and a second location in the concealed position within the housing and generally vertically above the display opening of the housing; and a vertical chain drive assembly disposed within the vertical conveyor assembly and comprised of a lift chain drive motor and a lift chain apparatus that only bends about its link rollers in a single direction, the vertical chain drive assembly configured to convey the lift frame and the video display cover attached to the lift frame in a back-and-forth generally vertical linear path to maintain the video display cover between the first location in the display opening of the housing flush with the wall in the revealed position and the second location in the concealed position within the housing and generally vertically above the display opening of the housing.

The installation structure further can include: at least one proximity sensor configured to communicate to the controller that the video display cover is in a correct position at either of the revealed position in the display opening or the concealed position within the housing; and at least one proximity sensor configured to communicate to the controller that the video display platform is in a correct position at either of the extended position flush with the wall or the retracted position hidden from view within the housing.

The installation structure also can include: at least one proximity sensor configured to communicate to the controller that the video display cover is in a correct position at either of the first location directly adjacent to the lift frame and the second location within the display opening mounted flush with the wall.

The installation structure further can include: a retractable access panel defined within the housing and configured to provide access to an internal housing area even while either the video display device or the video display cover is flush with the wall; and a counterweight apparatus disposed within the housing and coupled to the vertical chain drive assembly to offset a weight of the lift frame and video display cover.

In another exemplary embodiment, the technology described herein provides a method for interchangeably concealing and viewing a video display. The method includes: providing a video display concealment and viewing apparatus, for interchangeably concealing and viewing a video display device, as selected by an operator, the apparatus comprising: a housing, the housing defined by a recessed area in a wall, or like structure, the housing defined by a display opening in the recessed area; a video display cover operable between a revealed position in the display opening and a concealed position within the housing to selectively, interchangeably rotate with a video display device, wherein one of the video display cover and the video display device is in the revealed position in the display opening while the other is in the concealed position within the housing; a video display platform operable between an extended position and a retracted position and configured securely to hold the video display device flush with the wall in the extended position and hidden from view within the housing in the retracted position; a lift frame upon which the video display cover is mounted and conveyed between the revealed position in the display opening and a concealed position within the housing; and a controller to control operator selected interchangeability between the video display cover and the video display device; extending, selectively, the video display platform to the extended position to hold the video display device flush with the wall, thereby concealing the video display cover to the concealed position within the housing; and retracting, selectively, the video display platform to the retracted position to hold the video display device hidden from view within the housing, thereby revealing the video display cover to the revealed position in the display opening.

The method also can include: providing a remote controller coupled in wireless communication to the controller to enable operation of the video display concealment and viewing apparatus remotely; and controlling, remotely, the video display concealment and viewing apparatus.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a video display concealment and viewing apparatus, illustrating, in particular, the video display flush with a wall surface, according to an embodiment of the technology described herein;

FIG. 2 is a front perspective view of the video display concealment and viewing apparatus depicted in FIG. 1, illustrating, in particular, the decorative cover flush with a wall surface, and covering the video display device, according to an embodiment of the technology described herein;

FIG. 3 is a front perspective view of the video display concealment and viewing apparatus depicted in FIG. 1, illustrating, in particular, the decorative cover flush in motion retracted from being flush with the wall surface and interchanging with the video display, according to an embodiment of the technology described herein;

FIG. 4 is a front perspective view of the video display concealment and viewing apparatus depicted in FIG. 1, illustrating, in particular, the decorative cover flush in motion retracted and lifted from being flush with the wall surface and interchanging with the video display, according to an embodiment of the technology described herein;

FIG. 5 is a front perspective view of the video display concealment and viewing apparatus depicted in FIG. 1, illustrating, in particular, the video display extending outwardly to be flush with the wall surface, according to an embodiment of the technology described herein;

FIG. 6 is a rear perspective view of the video display concealment and viewing apparatus depicted in FIG. 1, illustrating, in particular, the lift frame structure, and the video display, platform, platform chain drive, remote lift controller, and power supply, according to an embodiment of the technology described herein;

FIG. 7A is a side view of the video display concealment and viewing apparatus depicted in FIG. 1, according to an embodiment of the technology described herein;

FIG. 7B is a side view of the video display concealment and viewing apparatus depicted in FIG. 1, according to an embodiment of the technology described herein;

FIG. 8A is a front perspective view of a drive mechanism in an extended position, according to an embodiment of the technology described herein;

FIG. 8B is a front perspective view of a drive mechanism in a retracted position, according to an embodiment of the technology described herein;

FIG. 8C is a side planar view of the drive mechanism depicted in FIGS. 8A and 8B, according to an embodiment of the technology described herein;

FIG. 9 is a rear view of the video display platform, platform chain drive assembly, and tracks, according to an embodiment of the technology described herein;

FIG. 10 is a rear view of the lift chain assembly, and the counterweight assembly, according to an embodiment of the technology described herein;

FIG. 11 is a rear view of the lift chain assembly and the lift motor, according to an embodiment of the technology described herein;

FIG. 12 is a front view of the video display upon the video display platform, according to an embodiment of the technology described herein;

FIG. 13 is a close-up front view of the video display upon the video display platform depicted in FIG. 12;

FIG. 14 is a rear perspective view of the video display platform, illustrating, in particular, an extension in which the display cover is extended into the wall opening, according to an embodiment of the technology described herein;

FIG. 15 is a functional block diagram illustrating communications and connectivity between the components of the video display concealment and viewing apparatus, according to an embodiment of the technology described herein; and

FIG. 16 is a process flow diagram for a video display concealment and viewing apparatus, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a device, system, and associated methods for a video display concealment and viewing apparatus

Referring now to the Figures a video display concealment and viewing apparatus 10 is shown. The apparatus 10 is utilized for interchangeably concealing and viewing a video display device 12, as selected by an operator. By way of example, the video display device 12 is a flat panel television. However, other video display devices 12 can be utilized with this apparatus 10.

The apparatus 10 and the video display device 12 utilized within the apparatus 10 reside in a housing. In at least one embodiment, the housing is a prefabricated cabinet system, or the like, into which the apparatus 10 video display device 12 is installed and within which the video display device 12 operatively is revealed and concealed. In at least one alternative embodiment, and as depicted in the Figures, the housing is defined within an existing wall 14. The wall 14 can be a drywall, brick, panel, or like wall structure. As such, the housing is defined by a recessed area within the wall 14. The housing also is defined by a display opening in the recessed area in the wall. The display opening provides viewing of the video display device 12.

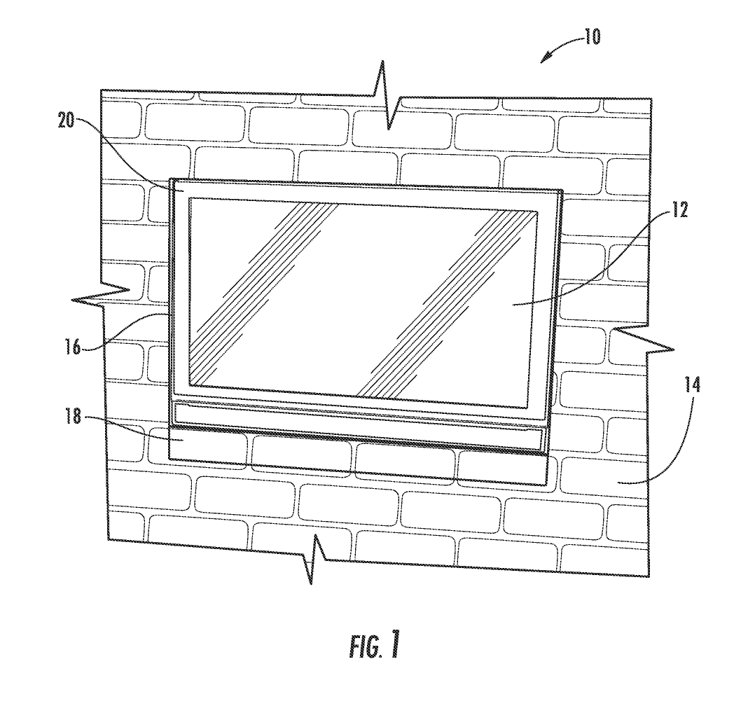

The apparatus is designed to provide the video display 12 flush with the wall 14 surface at opening edge 16. As depicted specifically in FIG. 1, the frame 20 of the video display device 12 meets wall 14 at opening edge 16 in a flush manner.

As depicted specifically in FIG. 1, the apparatus includes a retractable access panel 18. The retractable access panel 18 is defined within the housing and configured to provide access to an internal housing area even while either the video display device 12 or the video display cover 22 is flush with the wall 14. By way of example, in one embodiment, the retractable access panel 18 is opened by depressing the panel 18 to release it from its mount. As the panel 18 opens, and swings outwardly and downwardly, for example, access is gained into the housing area.

As depicted specifically in FIG. 2, the apparatus 10 is illustrated with a video display cover 22. As shown, the video display cover 22 is a painting. However, alternative items can be utilized for the video display cover 22 so long as the chosen cover item covers the opening in the housing defined in the wall 14 and allows for the frame 24, or the like, of the video display cover 22 to meet the wall 14 in a flush manner at opening edge 16.

The video display cover 22 is operable between a revealed position in the display opening and a concealed position within the housing to selectively, to interchangeably rotate with a video display device 12. One of the video display cover 22 and the video display device 12 is in the revealed position in the display opening while the other is in the concealed position within the housing.

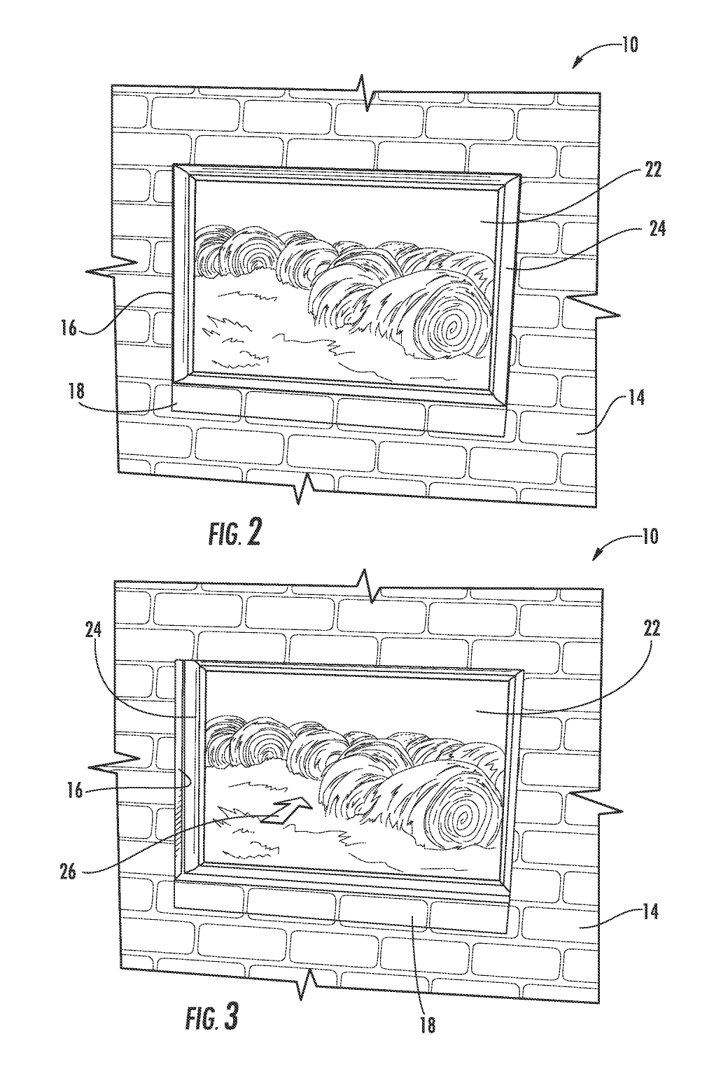

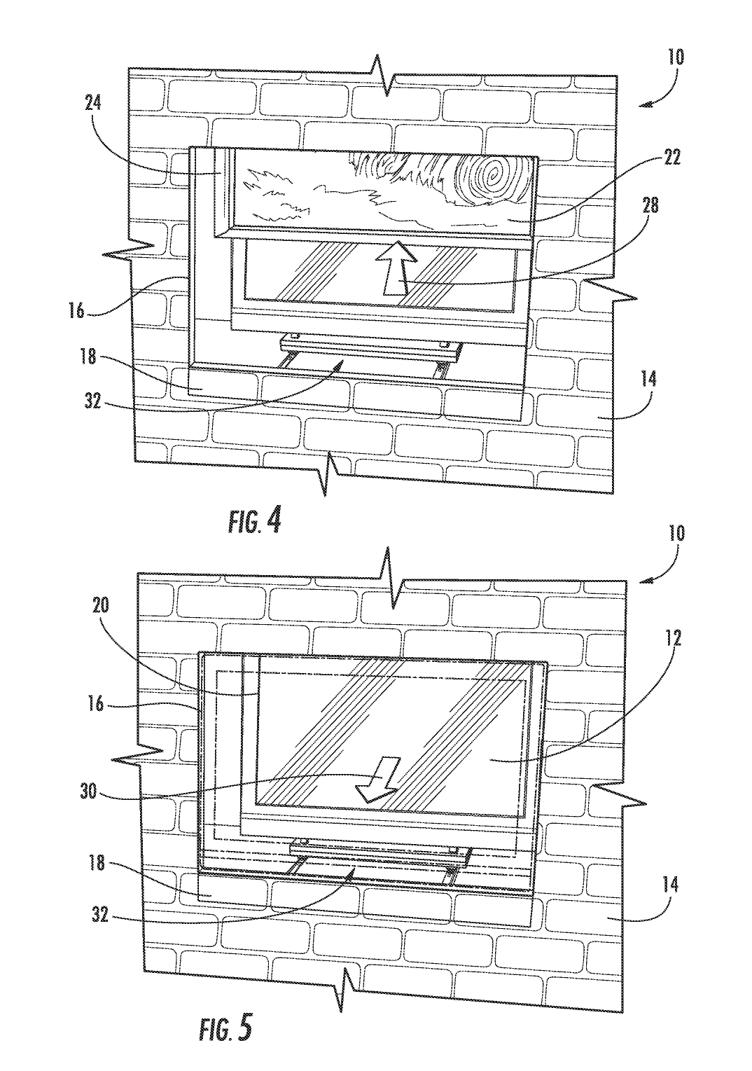

As depicted specifically in FIG. 3, the video display cover 22 is retracted from opening edge 16 of the wall 14, in the direction of arrow 26, back into the housing. The means by which the video display cover 22 is controlled (extended, retracted, raised, and lowered) is separate and independent from the means by which the video display device 12 is controlled (extended and retracted), as will be described subsequently in greater detail.

As depicted specifically in FIG. 4, the video display cover 22 is raised (after being retracted, as shown in FIG. 3) in the direction of arrow 28. As the video display cover 22 is raised, the video display device 12, upon a platform assembly 32, is revealed sunken into the housing in its previously concealed state.

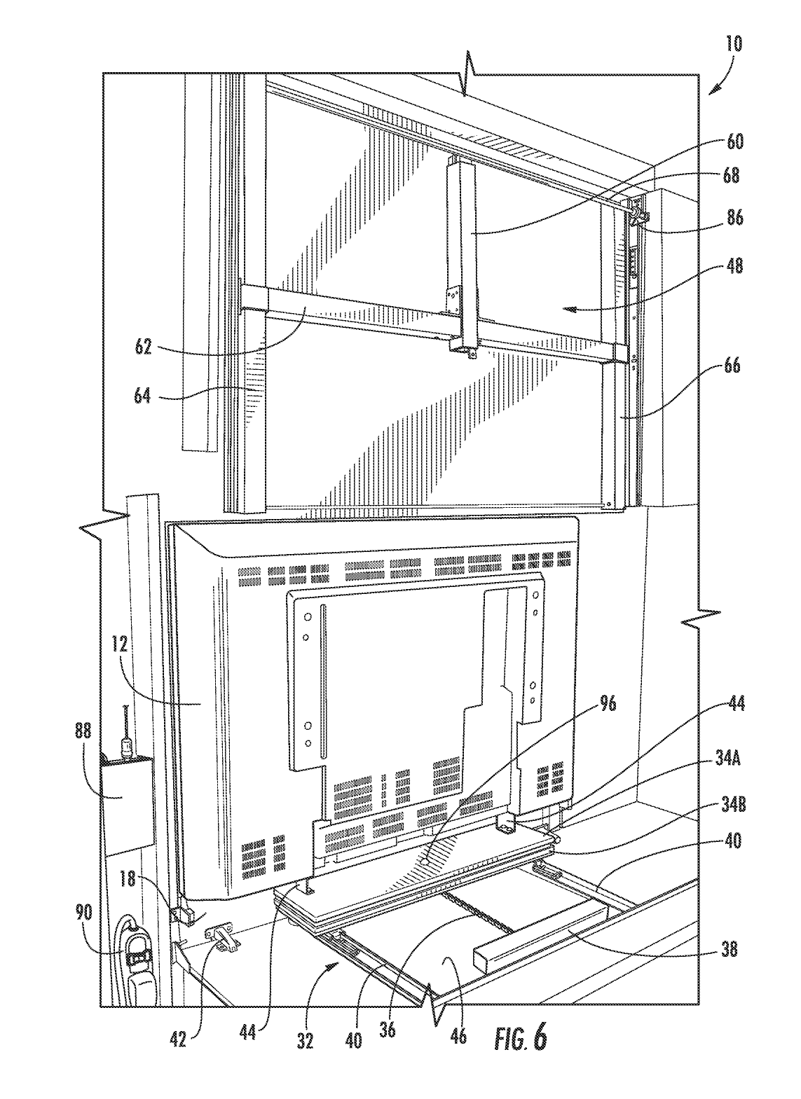

As depicted specifically in FIG. 5, the video display device 12, mounted upon a movable platform assembly 32, is extended outwardly in the direction of arrow 30. The video display device 12 is extended up to the opening in wall 14 such that the frame 20 of the video display device 12 meets in a flush manner at opening edge 16, as depicted in FIG. 1.

FIGS. 7A and 7B provide a side views of the video display device 12 and the video display cover 22. As shown in FIG. 7A, the video display 12 is flush with the wall 14, as depicted in a front view in FIG. 1. When the video display device 12 is in this position, the video display cover 22 is above in the housing. As shown in FIG. 7B, Video display device 12 can be retracted on assembly 32 with platform 34 on tracks driven by chain 36. Once the video display device 12 is retracted, room is provided for the video display cover 22 to be lowered and extended outwardly to be flush with wall 14, as depicted from a front view in FIG. 2.

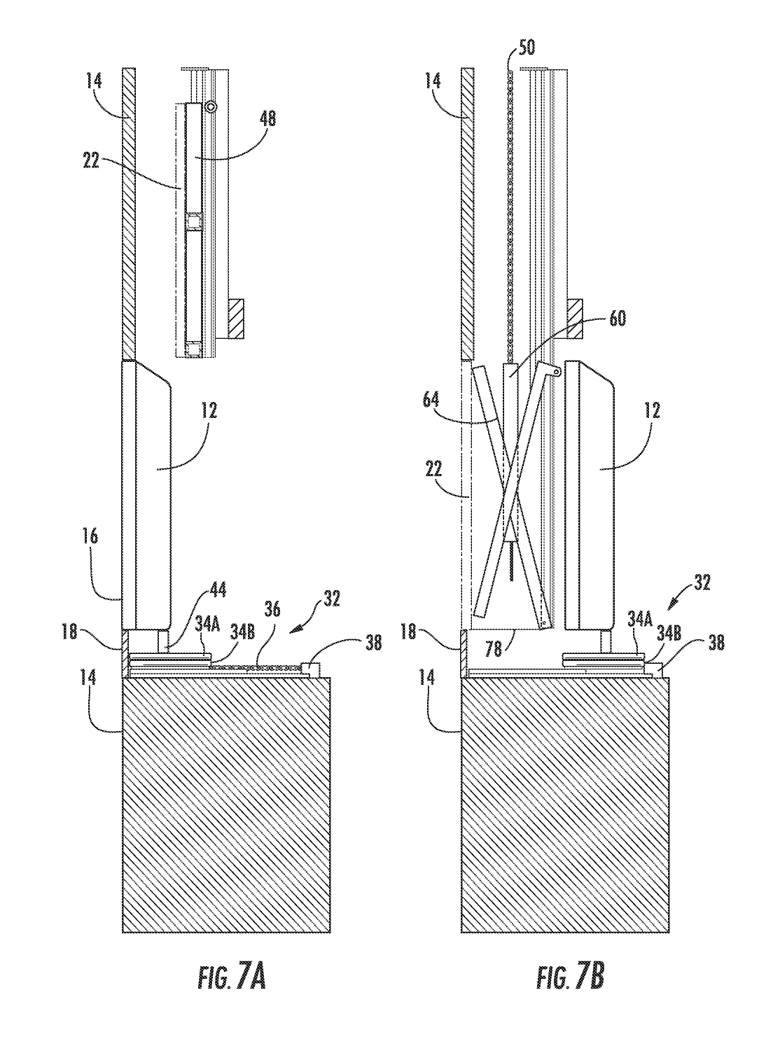

As depicted specifically in FIG. 6, the movable platform assembly 32 includes a video display platform 34. The video display platform 34 is operable between an extended position and a retracted position. The video display platform 34 is operable to rotate about pivot 96. The video display platform 34 is configured securely to hold the video display device 12 flush with the wall 14 in the extended position and hidden from view within the housing in the retracted position. A video display device 12 can be mounted to the video display platform 34 with mounts 44.

FIG. 6 additionally provides a rear view of the retractable access panel 18, described previously. The retractable access panel 18 can be attached to the housing via one or more magnetic push hinge 42.

The video display platform 34 is configured to slide (extend and retract based on user input) on tracks 40 mounted to a base 46. As depicted in the Figures, two tracks 40 are utilized. In at least one embodiment, the track 40 is a ball bearing slide.

The apparatus 10 includes a power source, such as one accessible through power strip 90. Power strip 90 provides access to a power circuit within a home or other building.

The apparatus includes a lift control 88. In at least embodiment, the lift control is accessible remotely.

In at least one embodiment, the video display platform 34 is driven by a platform chain 36. A horizontal conveyer assembly 38 is coupled to the video display platform 34 and configured to convey the video display platform 34 in a back-and-forth generally horizontal linear path in order to maintain the video display device 12 between a first location in the display opening of the housing flush 16 with the wall 14 in the extended position and a second location hidden from view within the wall 14 in the retracted position.

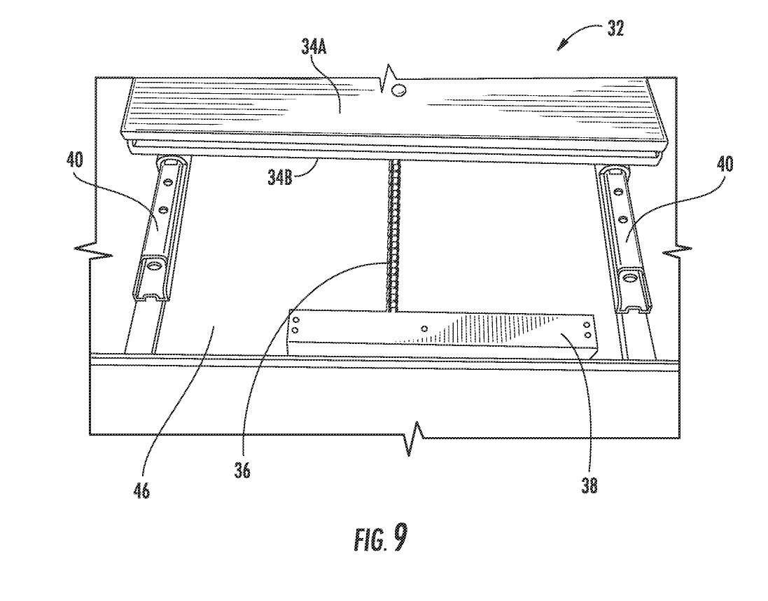

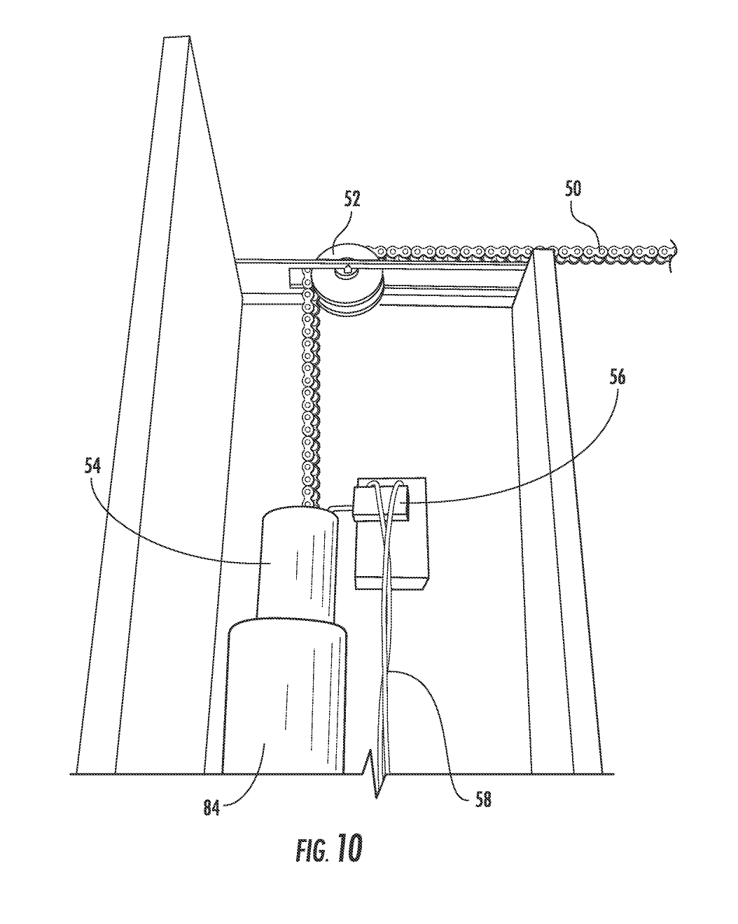

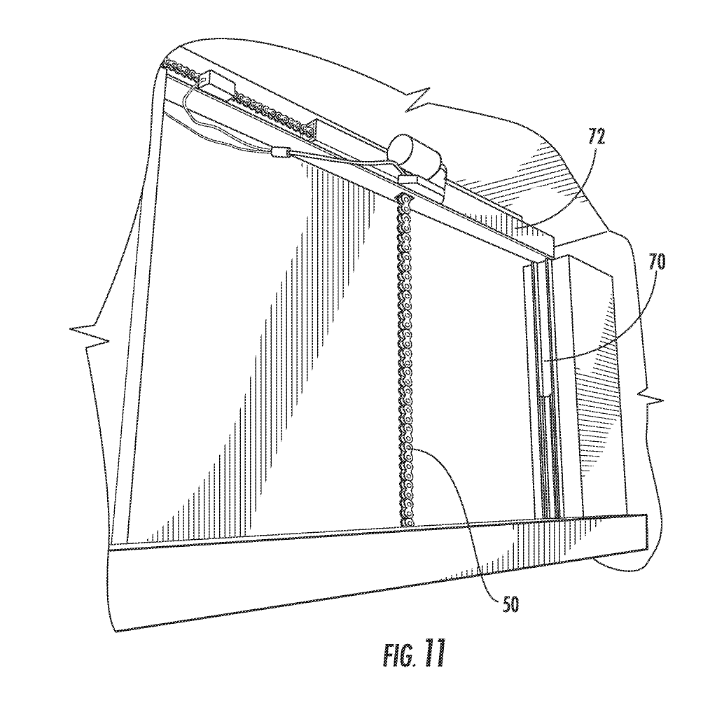

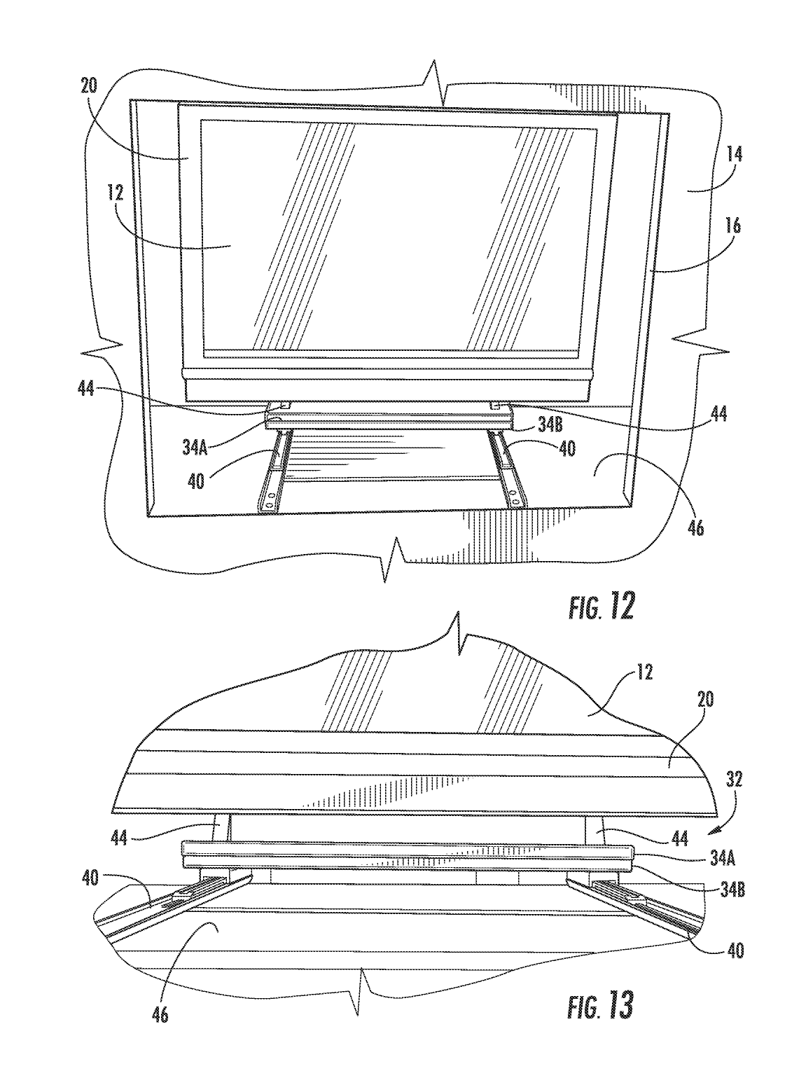

In at least one embodiment, a horizontal chain drive assembly 38 is disposed within the horizontal conveyer assembly 38 and includes a chain drive motor and a platform chain apparatus 36 that only bends about its link rollers in a single direction. A close-up view of the movable platform assembly 32, horizontal chain drive assembly 38, and the platform chain 36 is provided in FIG. 9.

The video display concealment and viewing apparatus 10 includes a lift frame 48. Upon the lift frame 48 the video display cover 22 is mounted and conveyed between the revealed position in the display opening and a concealed position within the housing. As depicted in the upper portion of FIG. 6, the lift frame 48 includes a multiplicity of hollow square tubes configured to house various components of the apparatus 10.

By way of example, the lift frame 48 can include a middle horizontal tube 62, an upper horizontal tube 72, a left vertical tube 64, a right vertical tube 66, and a middle vertical tube 60. The lift frame 48 can move up and down along vertical tracks 70. The lift frame 48 can pivot relative to vertical tracks 70 in an X formation (perpendicular to wall 14) with a top portion pivoting relative to horizontal rod 68 with rollers 86, and with a lower portion pivoting relative a similar horizontal bar and rollers. This pivot means provides that a video display cover 22 mounted on the lift frame 48 can be not only lowered by the lift chain 50, but also extended outwardly, analogous to scissors opening, from the lift frame 48 to be placed within the display opening of the housing. This outward extension is actuated by the movement of the display drive assembly, described subsequently in more detail, mounted in each of the left vertical tube 64 and the right vertical tube 66.

The apparatus 10 includes a vertical conveyor assembly coupled to the lift frame 48 and configured to convey the lift frame 48 and the video display cover 22 attached to the lift frame 48 in a back-and-forth generally vertical linear path to maintain the video display cover 22 in between a first location in the display opening of the housing flush with the wall 14 in the revealed position and a second location in the concealed position within the housing and generally vertically above the display opening of the housing.

A vertical chain drive assembly is disposed within the vertical conveyor assembly and includes a lift chain 50 that only bends about its link rollers in a single direction and a lift chain drive motor (directly above the lift chain 50). Portions of lift chain 50 are moved through upper horizontal tube 72 and middle vertical tube 60.

The apparatus 10 includes a counterweight apparatus 54 disposed within the housing and coupled to the vertical chain drive assembly to offset a weight of the lift frame 48 and video display cover 22. The counterweight apparatus can extend from protective sleeve 84 when the lift frame 48 and video display cover 22 are lowered. Lift chain 50 rotates over pulley 52. As counterweight apparatus 54 is raised upwardly and makes contact with sensor 56, the movement of lift chain 50 ceases. Circuit 58 communicates the contact with the sensor 56 to the controller 114. At this point the lift frame 48 and video display cover 22 are lowered to a correct height such that the display drive assemblies 74 can “push” and extend outwardly the video display cover 22, with the scissors motion of the left vertical tube 64 and the right vertical tube 66 relative to their respective mounts, so that the video display cover 22 fits in a flush manner is the display opening around edge 16 in wall 14.

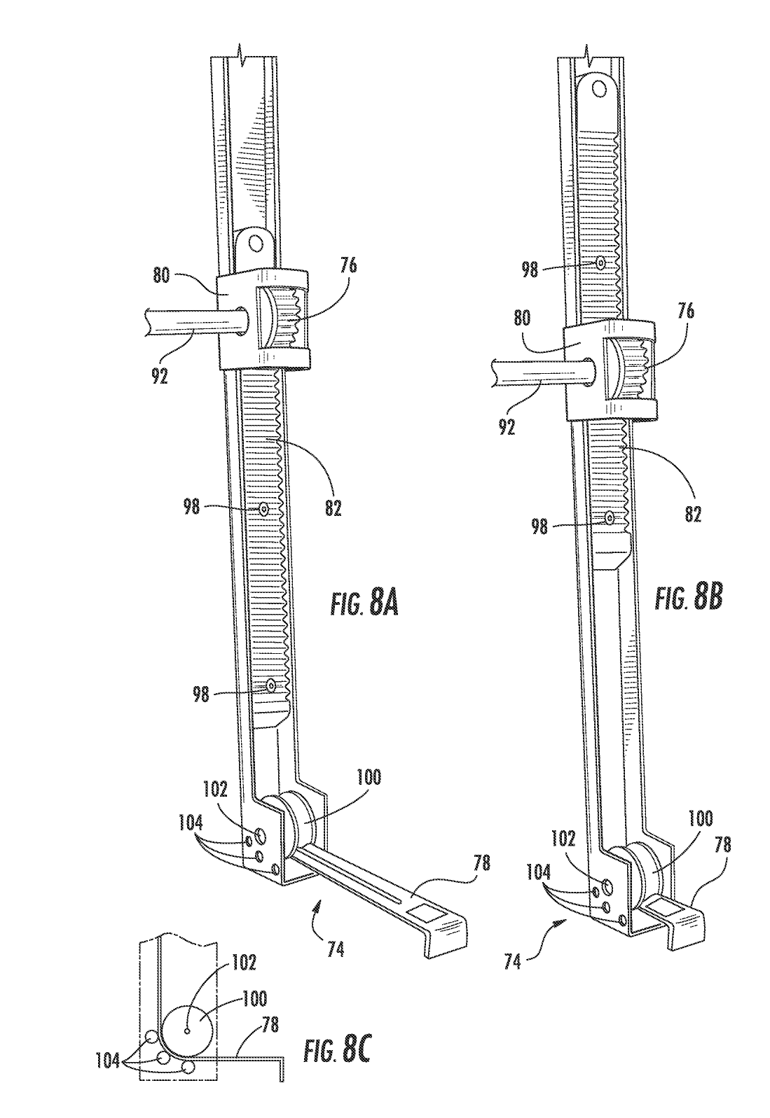

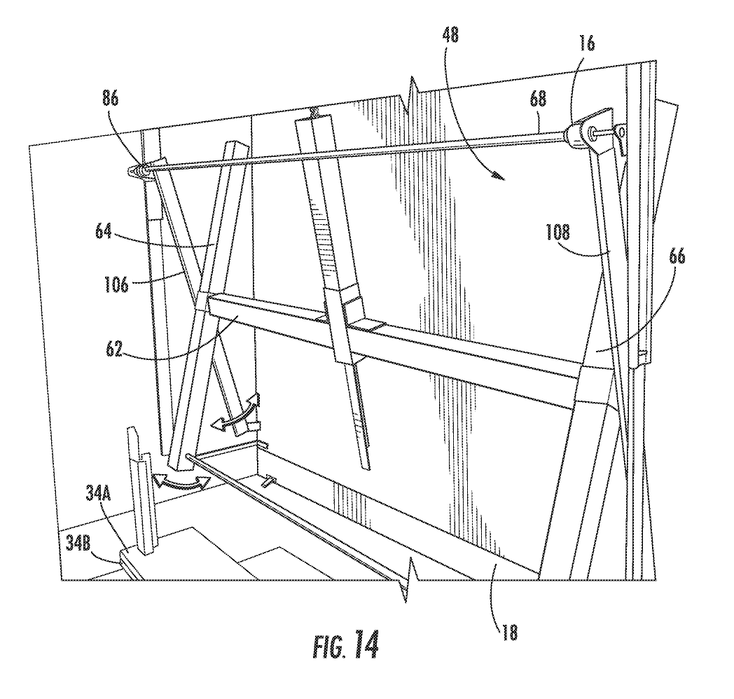

The display drive assembly 74 is best depicted in FIGS. 8A, 8B, and 8C. One display drive assembly 74 is located within the left vertical tube 64. A second display drive assembly 74 is located within the right vertical tube 66. Each display drive assembly 74 includes a pinion wheel 76 within cover 80. The pinion wheel can be covered in either the left vertical tube 64 where it intersects with the middle horizontal tube 62 or in the right vertical tube 66 where it intersects with the middle horizontal tube 62. The pinion wheels 76 are coupled via axle 92, disposed within the middle horizontal tube 62, or similar horizontal tube. As axle 92 is rotated, pinion wheels 76 rotate and interact with racks 82, to which attachment is made via rivet 98, to drive spring steel plates 78 outwardly, curving around wheel 100. The extension is facilitated over wheel 100 on axle 102 with capstan rollers 104. As the spring steel plates 78 are extended outwardly, the lift frame 48 extends to “push” outwardly the video display cover 22. The extension of the spring steel plates 78 pushes left extender 106 and right extender 108 outwardly, as depicted specifically in FIG. 14, shown with the display device removed, to place the video display cover 22 in the wall 14. The motion is analogous to scissors opening, from the lift frame 48 to be placed within the display opening of the housing.

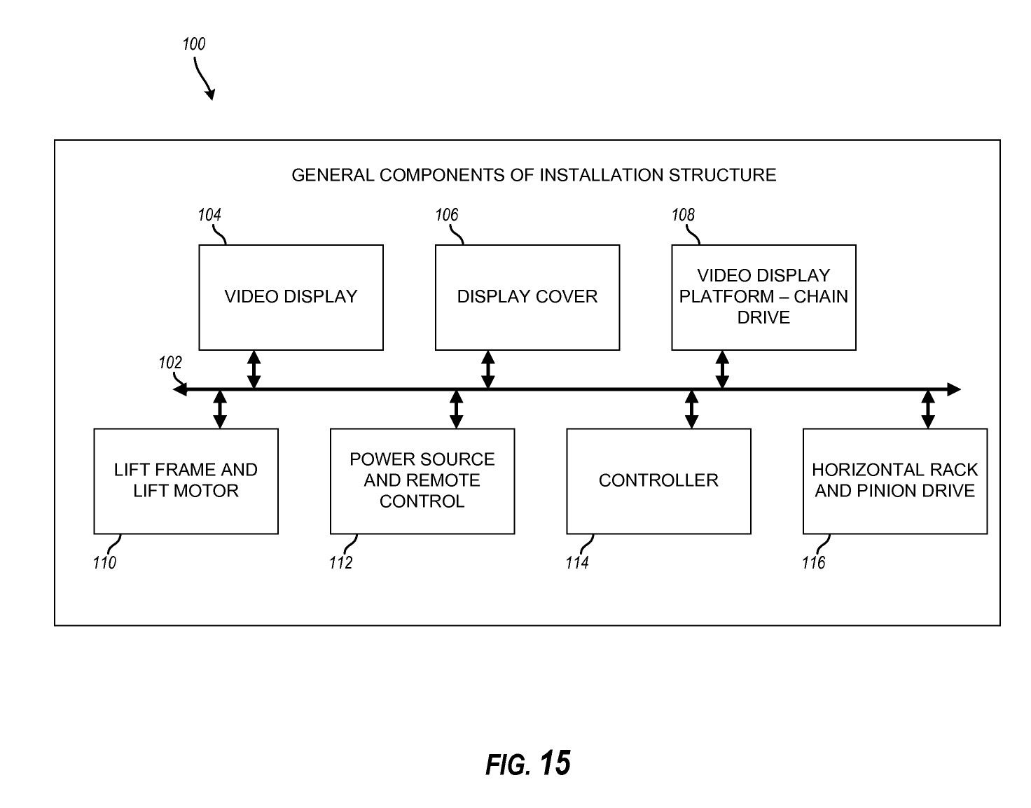

As depicted specifically in FIG. 15, the general components of the video display concealment and viewing apparatus 10 are illustrated in diagram 100. The apparatus 10 components are in operative communication with one another via circuit or bus 102. Controller 114 is powered by power source 112 to control a video display platform chain drive 108. Controller 114 controls the movement of the video display platform chain drive 108 to move the video display 108 in an extension or retraction. Controller 114 controls lift frame 110 and lift motor to move the display cover 106 in raising and lowering the display cover 106. Controller 114 controls rack and pinion drive mounted within the lift frame 110 to move the display cover in an extension or retraction.

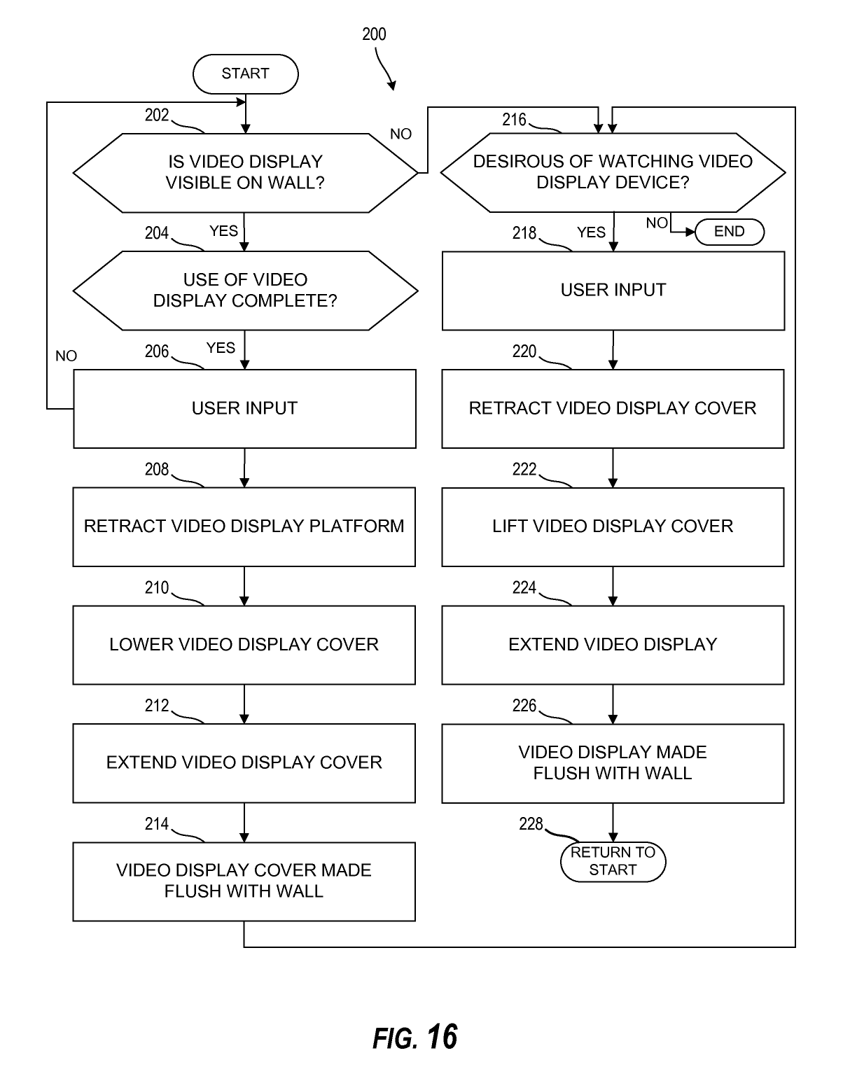

As depicted specifically in FIG. 16, a flowchart diagram 200 provides for a process flow diagram for the video display concealment and viewing apparatus. At step 202 it is inquired whether the video display is currently visible to the operator. If NO, proceed to step 216. If YES, proceed to step 204. At step 204, it is inquired whether use of the video display is complete. If YES, proceed to step 206. If NO, return to START. At step 206, user input is processed. At step 208, the video display platform is retracted. At step 208, the video display cover is lowered. At step 210, the video display cover is extended. At step 212, the video display cover is made flush with the wall. At step 216, it is inquired whether the operator is desirous of watching display device. If YES, proceed to step 218. If NO, proceed to END. At step 218, user input is processed. At step 220, the video display cover is retracted. At step 222, the video display cover is lifted. At step 224, the video display is extended. At step 226, the video display is made flush with the wall. At step 228, return to START.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A video display concealment and viewing apparatus, for interchangeably concealing and viewing a video display device, as selected by an operator, the apparatus comprising:
a housing, the housing defined by a recessed area in a wall, or like structure, the housing defined by a display opening in the recessed area;
a video display cover operable between a revealed position in the display opening and a concealed position within the housing to selectively, interchangeably rotate with a video display device, wherein one of the video display cover and the video display device is in the revealed position in the display opening while the other is in the concealed position within the housing;
a video display platform operable between an extended position and a retracted position and configured securely to hold the video display device flush with the wall in the extended position and hidden from view within the housing in the retracted position;
a lift frame upon which the video display cover is mounted and conveyed between the revealed position in the display opening and a concealed position within the housing; and
a controller to control operator selected interchangeability between the video display cover and the video display device.

2. The apparatus of claim 1, further comprising:
a horizontal conveyer assembly coupled to the video display platform and configured to convey the video display platform in a back-and-forth generally horizontal linear path in order to maintain the video display device between a first location in the display opening of the housing flush with the wall in the extended position and a second location hidden from view within the wall in the retracted position.

3. The apparatus of claim 1, further comprising:
a vertical conveyor assembly coupled to the lift frame and configured to convey the lift frame and the video display cover attached to the lift frame in a back-and-forth generally vertical linear path to maintain the video display cover in between a first location in the display opening of the housing flush with the wall in the revealed position and a second location in the concealed position within the housing and generally vertically above the display opening of the housing.

4. The apparatus of claim 2, further comprising:
a horizontal chain drive assembly disposed within the horizontal conveyer assembly and comprised of a chain drive motor and a chain apparatus that only bends about its link rollers in a single direction, the horizontal chain drive assembly configured to convey the video display platform in a back-and-forth generally horizontal linear path in order to maintain the video display device between the first location in the display opening of the housing flush with the wall in the extended position and the second location hidden from view within the wall in the retracted position.

5. The apparatus of claim 3, further comprising:
a vertical chain drive assembly disposed within the vertical conveyor assembly and comprised of a lift chain drive motor and a lift chain apparatus that only bends about its link rollers in a single direction, the vertical chain drive assembly configured to convey the lift frame and the video display cover attached to the lift frame in a back-and-forth generally vertical linear path to maintain the video display cover between the first location in the display opening of the housing flush with the wall in the revealed position and the second location in the concealed position within the housing and generally vertically above the display opening of the housing.

6. The apparatus of claim 5, further comprising:
a counterweight apparatus disposed within the housing and coupled to the vertical chain drive assembly to offset a weight of the lift frame and video display cover.

7. The apparatus of claim 1, further comprising:
a remote controller coupled in wireless communication to the controller to enable operation of the video display concealment and viewing apparatus remotely.

8. The apparatus of claim 1, further comprising:
a rack and pinion wheel assembly coupled to a display cover drive assembly, the rack and pinion wheel assembly disposed with the lift frame and configured selectively to push and pull the video display cover, once the video display cover is lowered from within the housing to immediately behind the display opening, between a first location directly adjacent to the lift frame and a second location within the display opening mounted flush with the wall.

9. The apparatus of claim 8, wherein the display cover drive assembly comprises a spring steel member coupled to the video display cover at a first end and coupled to the rack and pinion wheel assembly at a second end, such that rotation of the pinion wheel against the rack moves the spring steel member and thus the video display cover.

10. The apparatus of claim 1, further comprising:
at least one proximity sensor configured to communicate to the controller that the video display cover is in a correct position at either of the revealed position in the display opening or the concealed position within the housing.

11. The apparatus of claim 1, further comprising:
at least one proximity sensor configured to communicate to the controller that the video display platform is in a correct position at either of the extended position flush with the wall or the retracted position hidden from view within the housing.

12. The apparatus of claim 1, further comprising:
at least one proximity sensor configured to communicate to the controller that the video display cover is in a correct position at either of the first location directly adjacent to the lift frame and the second location within the display opening mounted flush with the wall.

13. The apparatus of claim 1, further comprising:
a retractable access panel defined within the housing and configured to provide access to an internal housing area even while either the video display device or the video display cover is flush with the wall.

14. An installation structure for a video display and an associated video display cover, the installation structure comprising:
a housing having an approximately rectangular recess or opening that is formed in a wall, cabinet, or the like, for accommodating a video display device;
a video display cover operable between a revealed position in the opening and a concealed position within the housing to selectively, interchangeably rotate with the video display device, wherein one of the video display cover and the video display device is in the revealed position in the display opening while the other is in the concealed position within the housing;
a video display platform operable between an extended position and a retracted position and configured securely to hold the video display device flush with the wall in the extended position and hidden from view within the housing in the retracted position;
a lift frame upon which the video display cover is mounted and conveyed between the revealed position in the display opening and a concealed position within the housing;
a controller to control operator selected interchangeability between the video display cover and the video display device; and
a rack and pinion wheel assembly coupled to a drive assembly, the rack and pinion wheel assembly disposed with the lift frame and configured selectively to push and pull the video display cover, once the video display cover is lowered from within the housing to immediately behind the display opening, between a first location directly adjacent to the lift frame and a second location within the display opening mounted flush with the wall, wherein the drive assembly comprises a spring steel member coupled to the video display cover at a first end and coupled to the rack and pinion wheel assembly at a second end, such that rotation of the pinion wheel against the rack moves the spring steel member and thus the video display cover.

15. The installation structure of claim 14, further comprising:
a horizontal conveyer assembly coupled to the video display platform and configured to convey the video display platform in a back-and-forth generally horizontal linear path in order to maintain the video display device between a first location in the display opening of the housing flush with the wall in the extended position and a second location hidden from view within the wall in the retracted position;
a horizontal chain drive assembly disposed within the horizontal conveyer assembly and comprised of a chain drive motor and a chain apparatus that only bends about its link rollers in a single direction, the horizontal chain drive assembly configured to convey the video display platform in a back-and-forth generally horizontal linear path in order to maintain the video display device between the first location in the display opening of the housing flush with the wall in the extended position and the second location hidden from view within the wall in the retracted position;
a vertical conveyor assembly coupled to the lift frame and configured to convey the lift frame and the video display cover attached to the lift frame in a back-and-forth generally vertical linear path to maintain the video display cover in between a first location in the display opening of the housing flush with the wall in the revealed position and a second location in the concealed position within the housing and generally vertically above the display opening of the housing; and
a vertical chain drive assembly disposed within the vertical conveyor assembly and comprised of a lift chain drive motor and a lift chain apparatus that only bends about its link rollers in a single direction, the vertical chain drive assembly configured to convey the lift frame and the video display cover attached to the lift frame in a back-and-forth generally vertical linear path to maintain the video display cover between the first location in the display opening of the housing flush with the wall in the revealed position and the second location in the concealed position within the housing and generally vertically above the display opening of the housing.

16. The installation structure of claim 14, further comprising:
at least one proximity sensor configured to communicate to the controller that the video display cover is in a correct position at either of the revealed position in the display opening or the concealed position within the housing; and
at least one proximity sensor configured to communicate to the controller that the video display platform is in a correct position at either of the extended position flush with the wall or the retracted position hidden from view within the housing.

17. The installation structure of claim 14, further comprising:
at least one proximity sensor configured to communicate to the controller that the video display cover is in a correct position at either of the first location directly adjacent to the lift frame and the second location within the display opening mounted flush with the wall.

18. The installation structure of claim 15, further comprising:
a retractable access panel defined within the housing and configured to provide access to an internal housing area even while either the video display device or the video display cover is flush with the wall; and
a counterweight apparatus disposed within the housing and coupled to the vertical chain drive assembly to offset a weight of the lift frame and video display cover.

19. A method for interchangeably concealing and viewing a video display, the method comprising:
providing a video display concealment and viewing apparatus, for interchangeably concealing and viewing a video display device, as selected by an operator, the apparatus comprising: a housing, the housing defined by a recessed area in a wall, or like structure, the housing defined by a display opening in the recessed area; a video display cover operable between a revealed position in the display opening and a concealed position within the housing to selectively, interchangeably rotate with a video display device, wherein one of the video display cover and the video display device is in the revealed position in the display opening while the other is in the concealed position within the housing; a video display platform operable between an extended position and a retracted position and configured securely to hold the video display device flush with the wall in the extended position and hidden from view within the housing in the retracted position; a lift frame upon which the video display cover is mounted and conveyed between the revealed position in the display opening and a concealed position within the housing; and a controller to control operator selected interchangeability between the video display cover and the video display device;
extending, selectively, the video display platform to the extended position to hold the video display device flush with the wall, thereby concealing the video display cover to the concealed position within the housing; and
retracting, selectively, the video display platform to the retracted position to hold the video display device hidden from view within the housing, thereby revealing the video display cover to the revealed position in the display opening.

20. The method of claim 19, further comprising:
providing a remote controller coupled in wireless communication to the controller to enable operation of the video display concealment and viewing apparatus remotely; and
controlling, remotely, the video display concealment and viewing apparatus.
